(19) United States
(12) Patent Application Publication
(10) Pub. No.: US 2013/0163742 A1
(43) Pub. Date: Jun. 27, 2013

(54) SYSTEM AND METHOD FOR RECOMMENDING PHONE NUMBER

(71) Applicant: SAMSUNG ELECTRONICS CO., LTD, Gyeonggi-do (KR)

(72) Inventors: Hun Lim, Gyeonggi-do (KR); Sun-young Jung, Gyeonggi-do (KR); Hyo-yong Jeong, Gyeonggi-do (KR)

(73) Assignee: SAMSUNG ELECTRONICS CO., LTD, Gyeonggi-do (KR)

(21) Appl. No.: 13/728,808

(22) Filed: Dec. 27, 2012

(30) Foreign Application Priority Data
Dec. 27, 2011 (KR) 10-2011-0143930

(51) Int. Cl. H04M 3/44

(52) U.S. Cl. CPC H04M 3/44
USPC 379/216.01

(57) ABSTRACT

A phone number recommending system and method. A user terminal for generating a phone number recommendation list includes a time information acquisition unit for acquiring information regarding a time taken to perform a call through the user terminal. The user terminal also includes a location information acquisition unit for acquiring information regarding a location where the call is performed. The user terminal further includes a call history generator for generating a call history of the user terminal based on the acquired time information and the acquired location information. The user terminal still further includes a phone number recommendation unit for generating a phone number recommendation list based on the generated call history, a current location of the user terminal, and a current time. The user terminal also includes a display unit for displaying the generated phone number recommendation list.

### CROSS-REFERENCE TO RELATED APPLICATION(S) AND CLAIM OF PRIORITY

The present application is related to and claims the benefit of Korean Patent Application No. 10-2011-0143930, filed on Dec. 27, 2011, in the Korean Intellectual Property Office, the disclosure of which is incorporated herein in its entirety by reference.

### TECHNICAL FIELD OF THE INVENTION

The present disclosure relates to a system and method for recommending a phone number, and more particularly, to a system and method for recommending a phone number based on a call history of a user.

### BACKGROUND OF THE INVENTION

Due to the development of technology and society, an interchange of contact information is frequent, which may require many phone numbers to be stored in a user terminal. To satisfy this requirement, a user terminal provides a telephone directory and a call history list to the user, in addition to a voice call function.

However, due to the many opportunities for interchanging contact information due to the development of multimedia, a user may need to manage hundreds or more phone numbers. Accordingly, it is sometimes difficult to efficiently search for a certain phone number in the telephone directory and the call history list.

### SUMMARY OF THE INVENTION

To address the above-discussed deficiencies of the prior art, it is a primary object to provide a system and method for recommending a phone number based on a call history of a user terminal.

The present disclosure also provides a system and method for recommending a phone number to a user terminal based on a call history including location information and time information.

The present disclosure also provides a system and method for recommending a phone number to a user terminal by using schedule information of a user and other users.

According to an aspect of the present disclosure, there is provided a user terminal for generating a phone number recommendation list. The user terminal includes a time information acquisition unit configured to acquire information regarding a time taken to perform a call through the user terminal. The user terminal also includes a location information acquisition unit configured to acquire information regarding a location where the call is performed. The user terminal further includes a call history generator configured to generate a call history of the user terminal based on the acquired time information and the acquired location information. The user terminal still further includes a phone number recommendation unit configured to generate a phone number recommendation list based on the generated call history, a current location of the user terminal, and a current time. The user terminal also includes a display unit configured to display the generated phone number recommendation list.

The user terminal may further include a schedule information acquisition unit configured to acquiring schedule information of a user associated with the user terminal, wherein the phone number recommendation unit generates the phone number recommendation list based on the acquired schedule information.

The schedule information acquisition unit may acquire schedule information of another user associated with another user terminal from a Social Network Service (SNS) server by using an identification (ID) associated with the user terminal or an ID of the user, and the phone number recommendation unit may generate the phone number recommendation list by using the schedule information of the user and the schedule information of another user.

The phone number recommendation unit may generate the phone number recommendation list based on a similarity to the current location of the user terminal, a similarity to the current time, and event information included in the schedule information.

The event information may include at least one of information regarding a birthday of an acquaintance of the user and information regarding a meeting with the acquaintance, and the phone number recommendation unit may insert a phone number of the acquaintance into the phone number recommendation list based on an identifying value of the acquaintance, which is included in the event information.

The time information may include at least one of information regarding a date when the call is performed, information regarding a day of the week when the call is performed, and information regarding a time when the call is performed, and the information regarding the date when the call is performed may include information regarding whether the date is a holiday.

The display unit may insert the phone number recommendation list into the top of a call history list of the user terminal.

The display unit may display the phone number recommendation list separately from the call history list of the user terminal.

According to another aspect of the present disclosure, there is provided a user terminal for receiving a phone number recommendation list. The user terminal includes a time information acquisition unit configured to acquire information regarding a time taken to perform a call through the user terminal. The user terminal also includes a location information acquisition unit configured to acquire information regarding a location where the call is performed. The user terminal further includes a call history provider configured to provide to a server a call history of the user terminal that is generated based on the acquired time information and the acquired location information. The user terminal still further includes a location information provider configured to provide the location information of the user terminal to the server. The user terminal also includes a recommended phone number receiver configured to receive from the server a phone number recommendation list that is generated by the server based on the provided call history, the provided location information, and a current time. The user terminal further includes a display unit configured to display the received phone number recommendation list.

The user terminal may further include a schedule information provider for providing schedule information of a user of the user terminal to the server, wherein the recommended phone number receiver receives the phone number recommendation list generated by the server based on the provided schedule information.

The recommended phone number receiver may receive the phone number recommendation list generated by the server based on the schedule information of another user associated with another user terminal, and the schedule information of another user of another user terminal may be acquired from a Social Network Service (SNS) server by using an identification (ID) of the user terminal or an ID of the user.

The recommended phone number receiver may receive the phone number recommendation list generated based on a similarity to the current location of the user terminal, a similarity to the current time, and event information included in the schedule information.

The event information may include at least one of information regarding a birthday of an acquaintance of the user and information regarding a meeting with the acquaintance, and a phone number of the acquaintance may be included in the phone number recommendation list based on an identifying value of the acquaintance, which is included in the event information.

The time information may include at least one of information regarding a date when the call is performed, information regarding a day of the week when the call is performed, and information regarding a time when the call is performed, and the information regarding the date when the call is performed may include information regarding whether the date is a holiday.

The display unit may insert the phone number recommendation list into the top of a call history list of the user terminal.

The display unit may display the phone number recommendation list separately from the call history list of the user terminal.

According to another aspect of the present disclosure, there is provided a server for providing a phone number recommendation list. The server includes a call history receiver configured to receive a call history of a user terminal, which includes information regarding a time taken to perform a call through the user terminal and information regarding a location where the call is performed. The server also includes a location information receiver configured to receive location information of the user terminal. The server further includes a phone number recommendation list generator configured to generate a phone number recommendation list based on the received call history, the received location information, and a current time. The server still further includes a phone number recommendation unit configured to provide the generated phone number recommendation list to the user terminal.

The server may further include a schedule information acquisition unit configured to acquire schedule information of a user of the user terminal, wherein the phone number recommendation list generator generates the phone number recommendation list based on the acquired schedule information.

The schedule information acquisition unit may acquire schedule information of another user associated with another user terminal from a Social Network Service (SNS) server by using an identification (ID) of the user terminal or an ID of the user, and the phone number recommendation list generator may generate the phone number recommendation list by using the schedule information of the user and the schedule information of another user.

The phone number recommendation list generator may generate the phone number recommendation list based on a similarity to a current location of the user terminal, a similarity to the current time, and event information included in the schedule information.

The event information may include at least one of information regarding a birthday of an acquaintance of the user and information regarding a meeting with the acquaintance, and the phone number recommendation list generator may insert a phone number of the acquaintance into the phone number recommendation list based on an identifying value of the acquaintance, which is included in the event information.

The time information may include at least one of information regarding a date when the call is performed, information regarding a day of the week when the call is performed, and information regarding a time when the call is performed, and the information regarding the data when the call is performed may include information regarding whether the date is a holiday.

The phone number recommendation list in the user terminal may be inserted into the top of a call history list of the user terminal.

The phone number recommendation list in the user terminal may be displayed separately from the call history list of the user terminal.

According to another aspect of the present disclosure, there is provided a method of generating a phone number recommendation list in a user terminal. The method includes acquiring information regarding a time taken to perform a call through the user terminal, acquiring information regarding a location where the call is performed, and generating a call history of the user terminal based on the acquired time information and the acquired location information. The method also includes generating a phone number recommendation list based on the generated call history, a current location of the user terminal, and a current time. The method further includes displaying the generated phone number recommendation list.

According to another aspect of the present disclosure, there is provided a method of receiving a phone number recommendation list in a user terminal. The method includes acquiring information regarding a time taken to perform a call through the user terminal, acquiring information regarding a location where the call is performed, providing to a server a call history of the user terminal that is generated based on the acquired time information and the acquired location information, and providing the location information of the user terminal to the server. The method also includes receiving from the server a phone number recommendation list that is generated by the server based on the provided call history, the provided location information, and a current time. The method further includes displaying the received phone number recommendation list.

According to another aspect of the present disclosure, there is provided a method of providing a phone number recommendation list in a server. The method includes receiving a call history of a user terminal, which includes information regarding a time taken to perform a call through the user terminal and information regarding a location where the call is performed. The method also includes receiving location information of the user terminal. The method further includes generating a phone number recommendation list based on the received call history, the received location information, and a current time. The method still further includes providing the generated phone number recommendation list to the user terminal.

According to another aspect of the present disclosure, there is provided a computer-readable recording medium storing a computer-readable program for executing the method of generating a phone number recommendation list in a user terminal.

According to another aspect of the present disclosure, there is provided a computer-readable recording medium storing a computer-readable program for executing the method of receiving a phone number recommendation list in a user terminal.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of a user terminal according to an embodiment of the present disclosure;

FIG. 2 is a flowchart illustrating a method of recommending a phone number in the user terminal, according to an embodiment of the present disclosure;

FIG. 3 is conceptual diagram of a phone number recommendation system according to another embodiment of the present disclosure;

FIG. 4 is a block diagram of a user terminal according to another embodiment of the present disclosure;

FIG. 5 is a block diagram of a server according to another embodiment of the present disclosure;

FIG. 6 is a signaling diagram illustrating a method of recommending a phone number, according to another embodiment of the present disclosure;

FIG. 7 illustrates a call history table according to an embodiment of the present disclosure;

FIG. 8 illustrates a schedule information table according to an embodiment of the present disclosure; and

FIGS. 9 and 10 illustrate displayed phone number recommendation lists according to an embodiment of the present disclosure.

### DETAILED DESCRIPTION OF THE INVENTION

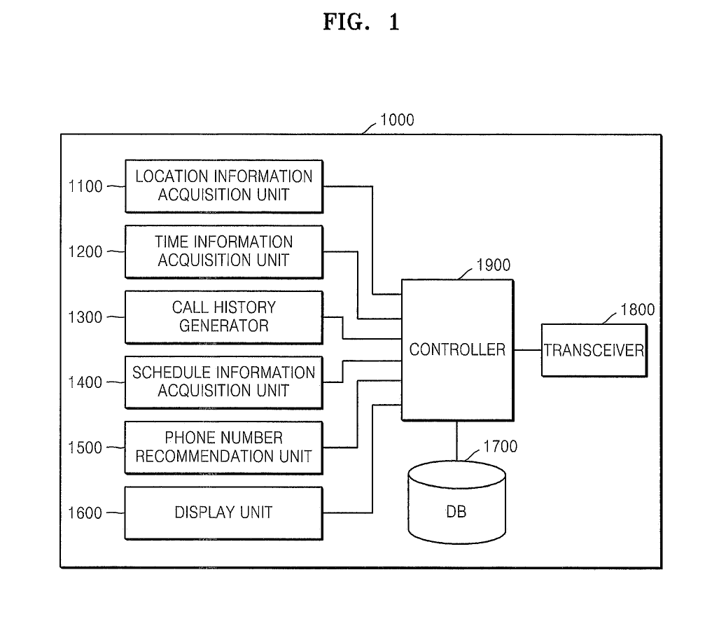

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. Embodiments of the present disclosure will now be described in detail for those of ordinary skill in the art to easily embody with reference to the accompanying drawings. The disclosure may, however, be embodied in many different forms and should not be construed as being limited to the embodiments set forth herein. In the drawings, parts regardless of description are omitted to clearly describe the present disclosure, and like reference numerals are used to refer to like elements throughout the specification.

When it is described that a certain element is ‘connected’ to another element in the specification, it should be understood that the certain element may be ‘directly connected’ to another element or ‘electrically connected’ via another element in the middle. In addition, when a certain element ‘includes’ a certain component, this indicates the existence of another component without excluding in advance the possibility of existence or addition of one or more other components unless the context clearly dictates otherwise. Expressions such as “at least one of,” when preceding a list of elements, modify the entire list of elements and do not modify the individual elements of the list.

A phone number recommendation system according to an embodiment of the present disclosure may generate a call history based on a time taken to perform a call through a user terminal and a location where the call is performed, and may generate a phone number recommendation list to be provided to a user according to a location of the user terminal. In addition, the phone number recommendation system may determine a phone number to recommend to the user by using schedule information of the user.

The present disclosure will now be described in detail with reference to the accompanying drawings.

FIG. 1 is a block diagram of a user terminal 1000 according to an embodiment of the present disclosure.

As shown in FIG. 1, the user terminal 1000 includes a location information acquisition unit 1100, a time information acquisition unit 1200, a call history generator 1300, a schedule information acquisition unit 1400, a phone number recommendation unit 1500, a display unit 1600, a database (DB) 1700, a transceiver 1800, and a controller 1900.

The location information acquisition unit 1100 acquires location information of a location where a call is performed with the user terminal 1000. The location information may include, for example, at least one of a Global Positioning System (GPS) value, an identification (ID) of a base station, Access Point (AP) information, and an Internet Protocol (IP) address.

The time information acquisition unit 1200 receives time information of when the call is performed with the user terminal 1000. The time information acquisition unit 1200 may acquire information regarding a date, a time, and a day of the week when the call is performed. The time information acquisition unit 1200 may also acquire information regarding whether the date when the call is performed is a weekday or a holiday. The time information acquisition unit 1200 may also identify the time when the call is performed as a predetermined time period. The predetermined time period may include at least one of, for example, dawn, morning, forenoon, noon, afternoon, evening, and night.

The time information acquisition unit 1200 may also acquire time information of when a user accesses a phone menu of the user terminal 1000 to make a call.

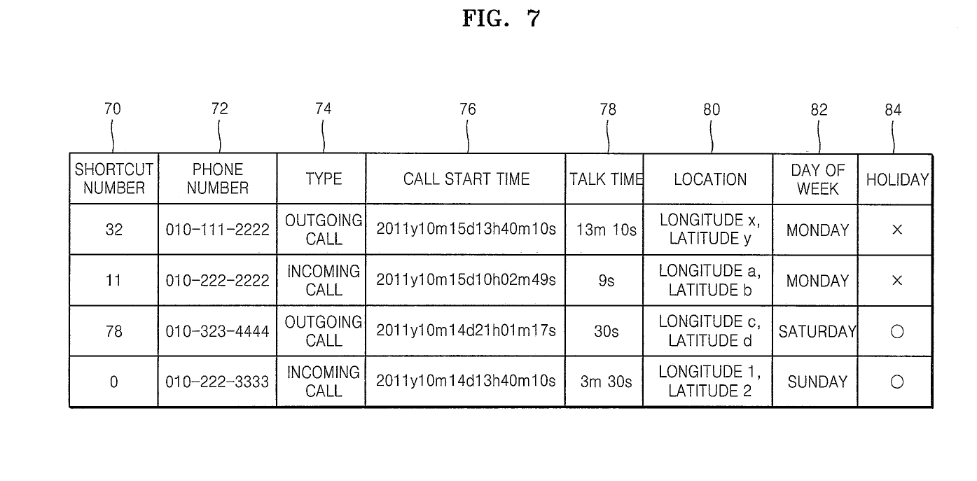

The call history generator 1300 generates a call history by using the acquired location information and the acquired time information. The call history generated by the call history generator 1300 may include at least one of, for example, a phone number of a called terminal, a shortcut number, a location of the user terminal 1000, a call start time, a talk time, and a day of the week, but is not limited thereto. The call history may also include information regarding whether the call is an incoming call or an outgoing call. The call history may also include information regarding whether the date when the call is performed is a holiday. A call history table generated by the call history generator 1300 will be described in detail with reference to FIG. 7.

The call history generated by the call history generator 1300 may also include information regarding a history of messages transmitted and received to and from other user terminals through a messenger program. In this situation, the call history may include identifying values of other user terminals and IDs of users using other user terminals.

The schedule information acquisition unit 1400 acquires schedule information of the user of the user terminal 1000. The schedule information is information regarding a schedule of the user and may include a plurality of pieces of event information. The event information may include, for example, information regarding a meeting, information regarding an event, and information regarding a birthday of an acquaintance of the user.

The schedule information acquisition unit 1400 may acquire schedule information of the user from a calendar file stored in the user terminal 1000 but is not limited thereto. The schedule information acquisition unit 1400 may acquire schedule information of the user from a Social Network Service (SNS) server (not shown) to which the user has subscribed, based on an ID of the user terminal 1000 or an ID of the user.

The schedule information acquisition unit 1400 may also acquire schedule information of another user associated with the user of the user terminal 1000. In this situation, the schedule information acquisition unit 1400 may acquire schedule information of another user associated with the user from the SNS server to which the user has subscribed, based on the ID of the user terminal 1000 or the ID of the user.

The phone number recommendation unit 1500 generates a phone number recommendation list based on a call history. The phone number recommendation unit 1500 may generate a phone number recommendation list by comparing each call breakdown included in a call history with a current time and a current location of the user terminal 1000. The phone number recommendation list may include, for example, phone numbers of other users and user IDs of a messenger program, but is not limited thereto.

The phone number recommendation unit 1500 may calculate similarities to a current time and a current location of the user terminal 1000 for each call breakdown included in a call history and determine phone numbers to be included in a phone number recommendation list based on the calculated similarities. In detail, the phone number recommendation unit 1500 may calculate time similarity based on a similar level between a current time and time information included in each call breakdown. The phone number recommendation unit 1500 may calculate time similarity to time information included in each call breakdown based on at least one of a call start time, a talk time, a call date, a day of the week, and whether the call date is a holiday with respect to a terminal corresponding to a phone number included in a call breakdown. The time similarity may have a high value when a current time is similar to a call start time. The time similarity may also have a high value when a current date is similar to a call date. The time similarity may also have a high value when a current day of the week is similar to a call day of the week.

In addition, the phone number recommendation unit 1500 may calculate location similarity based on a similar level between a current location of the user terminal 1000 and location information included in each call breakdown. The location similarity may have a high value when a current location of the user terminal 1000 is near a location where a call has been performed. However, the present disclosure is not limited thereto, and the phone number recommendation unit 1500 may calculate the time similarity and the location similarity according to various criteria and algorithms.

The phone number recommendation unit 1500 may generate a phone number recommendation list based on schedule information of the user. The phone number recommendation unit 1500 may check an event included in the schedule information by using the schedule information stored in the user terminal 1000 and insert a phone number included in the checked event into the phone number recommendation list. The phone number recommendation unit 1500 may check events, such as, for example, a meeting, a conference, and a birthday of an acquaintance, in the schedule information of the user and extract phone numbers regarding the meeting, the conference, and the birthday of the acquaintance from the schedule information. In this situation, the phone number recommendation unit 1500 may identify each event from the schedule information by using various natural language analysis schemes and extract a phone number from each event.

The phone number recommendation unit 1500 may insert a phone number corresponding to an event into a phone number recommendation list generated on a date and a time corresponding to the event. For example, if Gil-Dong Hong's birthday is September 4^{th}, the phone number recommendation unit 1500 may check Gil-Dong Hong's birthday in the schedule information. In addition, when the phone number recommendation unit 1500 generates a phone number recommendation list on September 4^{th} the phone number recommendation unit 1500 may insert a phone number of Gil-Dong Hong into the phone number recommendation list.

The phone number recommendation unit 1500 may receive schedule information of the user of the user terminal 1000 from the SNS server. In this situation, the phone number recommendation unit 1500 may receive the schedule information of the user from the SNS server by using the ID of the user terminal 1000 or the ID of the user. The phone number recommendation unit 1500 may also receive schedule information of an acquaintance of the user from the SNS server and generate a phone number recommendation list based on the schedule information of the acquaintance. In this situation, the phone number recommendation unit 1500 may generate the phone number recommendation list by using event information included in the schedule information of the acquaintance. The event information included in the schedule information of the acquaintance may include, for example, information regarding a birthday of the acquaintance or a meeting with the acquaintance.

The phone number recommendation unit 1500 may also accumulate time similarity and location similarity information with respect to each call breakdown included in the call history and may generate a phone number recommendation list by using the accumulated similarities. In this situation, the phone number recommendation unit 1500 may set a predetermined duration for accumulating similarities. The phone number recommendation unit 1500 may also generate the phone number recommendation list by using a mean value of the time similarity and the location similarity.

The display unit 1600 displays the phone number recommendation list on a screen of the user terminal 1000. The display unit 1600 may insert the phone number recommendation list on the top of a call history list of the user terminal 1000. The display unit 1600 may display the phone number recommendation list on the screen of the user terminal 1000 separately from the call history list.

The DB 1700 stores various kinds of information associated with the user terminal 1000 to generate and display a phone number recommendation list based on a call history. The DB 1700 may store call history information and schedule information of the user but is not limited thereto.

The transceiver 1800 transmits and receives various kinds of information to and from an external server in order for the user terminal 1000 to generate and display a phone number recommendation list based on a call history.

The controller 1900 controls the entire operation of the user terminal 1000, and controls the location information acquisition unit 1100, the time information acquisition unit 1200, the call history generator 1300, the schedule information acquisition unit 1400, the phone number recommendation unit 1500, the display unit 1600, the DB 1700, and the transceiver 1800 in order for the user terminal 1000 to generate and display a phone number recommendation list based on a call history.

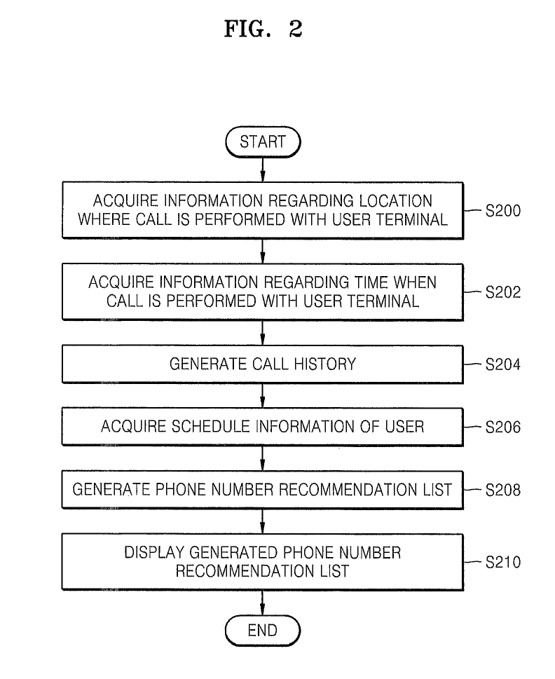

A method of recommending a phone number in the user terminal 1000 according to an embodiment of the present disclosure will now be described with reference to FIG. 2.

FIG. 2 is a flowchart illustrating a method of recommending a phone number in the user terminal 1000, according to an embodiment of the present disclosure.

In operation 5200, the user terminal 1000 acquires information regarding a location where a call is performed with the user terminal 1000. The location information may include, for example, at least one of a GPS value, an ID of a base station, AP information, and an IP address.

In operation 5202, the user terminal 1000 acquires information regarding a time when the call is performed with the user terminal 100. The user terminal 1000 may acquire information regarding a date, a time, and a day of the week when the call is performed. The user terminal 1000 may also acquire information regarding whether the date when the call is performed is a weekday or a holiday. The user terminal 1000 may also identify the time when the call is performed as a predetermined time period, and the predetermined time period may include at least one of, for example, dawn, morning, forenoon, noon, afternoon, evening, and night. The user terminal 1000 may also acquire time information of when the user accesses a phone menu of the user terminal 1000 to make a call.

In operation S204, the user terminal 1000 generates a call history by using the location information and the time information. The call history generated by the user terminal 1000 may include at least one of, for example, a phone number of a called terminal, a shortcut number, a location of the user terminal 1000, a call start time, a talk time, and a day of the week, but is not limited thereto. The call history may also include information regarding whether the call is an incoming call or an outgoing call. The call history may also include information regarding whether the date when the call is performed is a holiday. The call history generated may also include information regarding a history of messages transmitted and received to and from other user terminals through a messenger program. In this situation, the call history may include identifying values of other user terminals and IDs of users using other user terminals.

In operation S206, the user terminal 1000 acquires schedule information of the user. The schedule information is information regarding a schedule of the user and may include a plurality of pieces of event information. The event information may include, for example, information regarding a meeting, information regarding an event, and information regarding a birthday of an acquaintance of the user.

In operation S206, the user terminal 1000 may acquire schedule information of the user from a calendar file stored in the user terminal 1000 but is not limited thereto. The user terminal 1000 may acquire schedule information of the user from an SNS server (not shown) to which the user has subscribed, based on the ID of the user terminal 1000 or the ID of the user.

The user terminal 1000 may also acquire schedule information of another user associated with the user of the user terminal 1000. In this situation, the schedule information acquisition unit 1400 may acquire schedule information of another user associated with the user from the SNS server to which the user has subscribed, based on the ID of the user terminal 1000 or the ID of the user.

In operation S208, the user terminal 1000 generates a phone number recommendation list. The user terminal 1000 may generate a phone number recommendation list by comparing each call breakdown included in a call history with a current time and a current location of the user terminal 1000. The phone number recommendation list may include, for example, phone numbers of other users and user IDs of a messenger program, but is not limited thereto.

In addition, the user terminal 1000 may calculate similarities to a current time and a current location of the user terminal 1000 with respect to each call breakdown included in the call history and determine phone numbers to be included in the phone number recommendation list based on the calculated similarities. In detail, the user terminal 1000 may calculate time similarity based on a similar level between a current time and time information included in each call breakdown. The user terminal 1000 may calculate time similarity to time information included in each call breakdown based on, for example, at least one of a call start time, a talk time, a call date, a day of the week, and whether the call date is a holiday with respect to a terminal corresponding to a phone number included in a call breakdown. The time similarity may have a high value when a current time is similar to a call start time. The time similarity may also have a high value when a current date is similar to a call date. The time similarity may also have a high value when a current day of the week is similar to a call day of the week.

In addition, the user terminal 1000 may calculate location similarity based on a similar level between a current location of the user terminal 1000 and location information included in each call breakdown. The location similarity may have a high value when a current location of the user terminal 1000 is near a location where a call has been performed. However, the present disclosure is not limited thereto, and the user terminal 1000 may calculate the time similarity and the location similarity according to various criteria and algorithms.

The user terminal 1000 may generate the phone number recommendation list based on schedule information of the user. The user terminal 1000 may check an event included in the schedule information by using the schedule information stored in the user terminal 1000 and insert a phone number included in the checked event into the phone number recommendation list. The user terminal 1000 may check events, such as, for example, a meeting, a conference, and a birthday of an acquaintance, in the schedule information of the user and extract phone numbers regarding the meeting, the conference, and the birthday of the acquaintance from the schedule information. In this situation, the user terminal 1000 may identify each event from the schedule information by using various natural language analysis schemes and extract a phone number from each event.

In addition, the user terminal 1000 may insert a phone number corresponding to an event into a phone number recommendation list generated on a date and a time corresponding to the event. For example, if Gil-Dong Hong's birthday is September 4^{th}, the user terminal 1000 may check Gil-Dong Hong's birthday in the schedule information. In addition, when the user terminal 1000 generates a phone number recommendation list on September 4^{th}, the user terminal 1000 may insert a phone number of Gil-Dong Hong into the phone number recommendation list.

In addition, the user terminal 1000 may receive schedule information of the user of the user terminal 1000 from the SNS server. In this situation, the user terminal 1000 may receive the schedule information of the user from the SNS server by using the ID of the user terminal 1000 or the ID of the user. The user terminal 1000 may also receive schedule information of an acquaintance of the user from the SNS server and generate a phone number recommendation list based on the schedule information of the acquaintance. In this situation, the user terminal 1000 may generate the phone number recommendation list by using event information included in the schedule information of the acquaintance. The event information included in the schedule information of the acquaintance may include, for example, information regarding a birthday of the acquaintance or a meeting with the acquaintance.

In addition, the user terminal 1000 may also accumulate time similarity and location similarity information with respect to each call breakdown included in the call history and may generate a phone number recommendation list by using the accumulated similarities. In this situation, the phone number recommendation unit 1500 may set a predetermined duration for accumulating similarities. The phone number recommendation unit 1500 may also generate the phone number recommendation list by using a mean value of the time similarity and the location similarity.

In operation 210, the user terminal 1000 displays the phone number recommendation list on a screen of the user terminal 1000. The user terminal 1000 may insert the phone number recommendation list on the top of a call history list of the user terminal 1000. The user terminal 1000 may display the phone number recommendation list on the screen of the user terminal 1000 separately from the call history list.

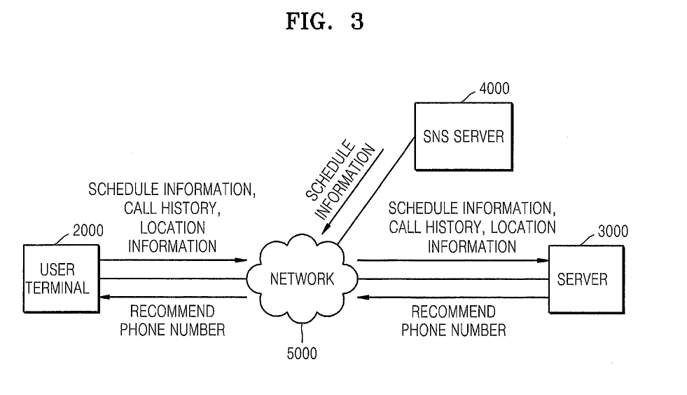

A phone number recommendation system according to another embodiment of the present disclosure will now be described with reference to FIG. 3.

FIG. 3 is conceptual diagram of a phone number recommendation system according to another embodiment of the present disclosure.

As shown in FIG. 3, the phone number recommendation system includes a user terminal 2000, a server 3000, an SNS server 4000, and a network 5000.

The user terminal 2000 may provide information regarding a call performed by the user terminal 2000 to the server 3000, receive a phone number recommendation list from the server 3000, and display the phone number recommendation list on a screen thereof.

The user terminal 2000 may provide a call history including location information and time information to the server 3000 and provide a current location of the user terminal 2000 and schedule information of a user to the server 3000. The user terminal 2000 may be able to perform a call with another terminal and includes every terminal connectable to the server 3000 via the network 5000. The user terminal 2000 may include, for example, at least one of a mobile phone, a smart phone, a Personal Digital Assistant (PDA), a laptop computer, a smart TV, and a Personal Computer (PC) but is not limited thereto.

The server 3000 generates a phone number recommendation list based on a call history of the user terminal 2000 and a current location of the user terminal 2000. The server 3000 may generate the phone number recommendation list based on schedule information of the user of the user terminal 2000 and schedule information of an acquaintance of the user. In this situation, the server 3000 may receive the schedule information of the user and the schedule information of the acquaintance from at least one of the user terminal 2000 and the SNS server 4000.

The network 5000 may be embodied by a wired network, such as a Local Area Network (LAN), a Wide Area Network (WAN), or a Value Added Network (VAN), or a wireless network, such as a mobile radio communication network or a satellite communication network. In addition, the network 5000 means generally a data communication network capable of allowing the network forming entities shown in FIG. 3 to smoothly communicate with each other. The network 5000 may include a wired Internet, a wireless Internet, and a mobile radio communication network.

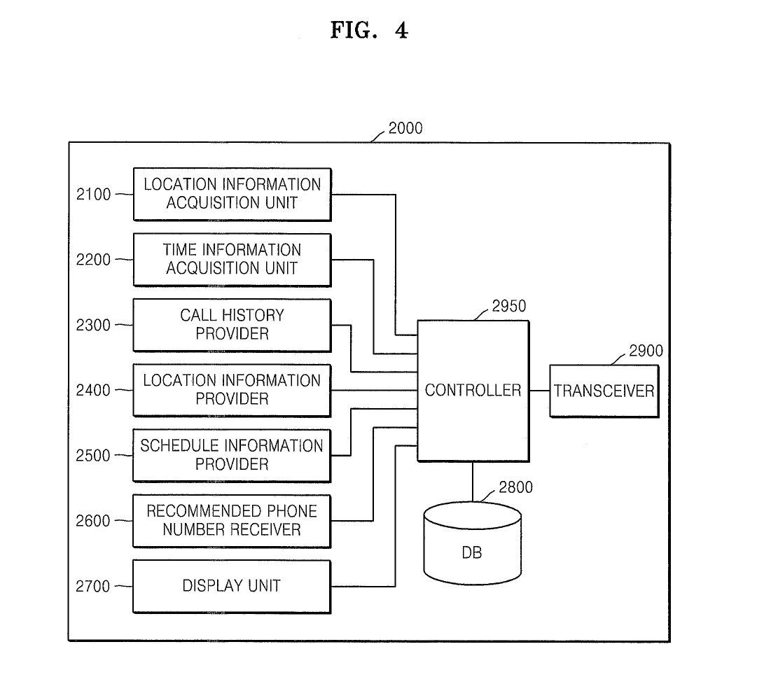

The user terminal 2000 according to another embodiment of the present disclosure will now be described with reference to FIG. 4.

FIG. 4 is a block diagram of the user terminal 2000 according to another embodiment of the present disclosure.

As shown in FIG. 4, the user terminal 2000 includes a location information acquisition unit 2100, a time information acquisition unit 2200, a call history provider 2300, a location information provider 2400, a schedule information provider 2500, a recommended phone number receiver 2600, a display unit 2700, a DB 2800, a transceiver 2900, and a controller 2950.

The location information acquisition unit 2100 acquires location information of a location where a call is performed with the user terminal 2000. The location information may include, for example, at least one of a GPS value, an ID of a base station, AP information, and an IP address.

The time information acquisition unit 2200 receives time information of when the call is performed with the user terminal 2000. The time information acquisition unit 2200 may acquire information regarding a date, a time, and a day of the week when the call is performed. The time information acquisition unit 2200 may also acquire information regarding whether the date when the call is performed is a weekday or a holiday. The time information acquisition unit 2200 may also identify the time when the call is performed as a predetermined time period, and the predetermined time period may include at least one of, for example, dawn, morning, forenoon, noon, afternoon, evening, and night.

The time information acquisition unit 2200 may also acquire time information of when a user accesses a phone menu of the user terminal 2000 to make a call.

The call history provider 2300 generates a call history by using the acquired location information and the acquired time information and provides the generated call history to the server 3000. The call history generated by the call history provider 2300 may include at least one of, for example, a phone number of a called terminal, a shortcut number, a location of the user terminal 2000, a call start time, a talk time, and a day of the week, but is not limited thereto. The call history may also include information, regarding whether the call is an incoming call or an outgoing call. The call history may also include information regarding whether the date when the call is performed is a holiday. A call history table generated by the call history provider 2300 will be described in detail with reference to FIG. 7.

The schedule information provider 2500 provides schedule information of the user of the user terminal 2000 to the server 3000. The schedule information is information regarding a schedule of the user and may include a plurality of pieces of event information. The event information may include, for example, information regarding a meeting, information regarding an event, and information regarding a birthday of an acquaintance of the user. The schedule information provider 2500 may extract schedule information of the user that is stored in the user terminal 2000 and provide the extracted schedule information to the server 3000, but is not limited thereto. The schedule information provider 2500 may collect schedule information of the user from the SNS server 4000 and provide the collected schedule information to the server 3000. In this situation, the schedule information provider 2500 may acquire schedule information of the user from the SNS server 4000 to which the user has subscribed, based on an ID of the user terminal 2000 or an ID of the user. The schedule information provider 2500 may also acquire schedule information of another user associated with the user of the user terminal 2000 and provide the acquired schedule information of another user to the server 3000. In this situation, the schedule information provider 2500 may acquire schedule information of another user (e.g., an acquaintance) associated with the user from the SNS server 4000 to which the user has subscribed, based on the ID of the user terminal 2000 or the ID of the user.

The location information provider 2400 provides information regarding a current location of the user terminal 2000 to the server 3000. The information regarding a current location of the user terminal 2000 may include, for example, at least one of a GPS value, an ID of a base station, AP information, and an IP address.

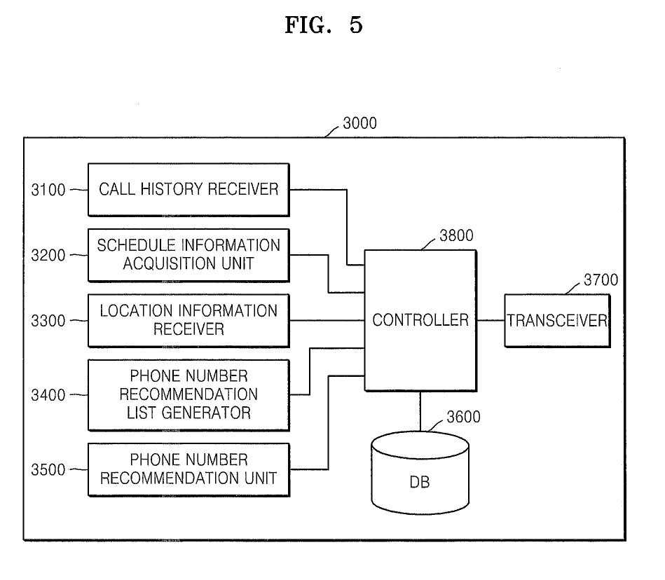

The recommended phone number receiver 2600 receives a phone number recommendation list from the server 3000. The phone number recommendation list may be generated by the server 3000 based on at least one of a call history of the user terminal 2000, a current location of the user terminal 2000, schedule information of the user, and schedule information of another user. The phone number recommendation list generated by the server 3000 will be described in detail with reference to FIG. 5.

The display unit 2700 displays the phone number recommendation list received from the server 3000 on the screen of the user terminal 2000. The display unit 2700 may insert the phone number recommendation list on the top of a call history list of the user terminal 2000. The display unit 2700 may display the phone number recommendation list on the screen of the user terminal 2000 separately from the call history list of the user terminal 2000.

The DB 2800 stores various kinds of information associated with the user terminal 2000 to receive and display a phone number recommendation list based on a call history. The DB 2800 may store call history information and schedule information of the user but is not limited thereto.

The transceiver 2900 transmits and receives various kinds of information to and from the server 3000 and the SNS server 4000 in order for the user terminal 2000 to receive and display a phone number recommendation list based on a call history.

The controller 2950 controls the entire operation of the user terminal 2000, and controls the location information acquisition unit 2100, the time information acquisition unit 2200, the call history provider 2300, the location information provider 2400, the schedule information provider 2500, the recommended phone number receiver 2600, the display unit 2700, the DB 2800, and the transceiver 2900 in order for the user terminal 2000 to receive and display a phone number recommendation list based on a call history.

The server 3000 according to another embodiment of the present disclosure will now be described with reference to FIG. 5.

FIG. 5 is a block diagram of the server 3000 according to another embodiment of the present disclosure.

As shown in FIG. 5, the server 3000 includes a call history receiver 3100, a schedule information acquisition unit 3200, a location information receiver 3300, a phone number recommendation list generator 3400, a phone number recommendation unit 3500, a DB 3600, a transceiver 3700, and a controller 3800.

The call history receiver 3100 receives a call history from the user terminal 2000. The call history may include at least one of, for example, a phone number of a called terminal, a shortcut number, a location of the user terminal 2000, a call start time, a talk time, and a day of the week, but is not limited thereto. The call history may also include information regarding whether the call is an incoming call or an outgoing call. The call history may also include information regarding whether the date when the call is performed is a holiday.

The schedule information acquisition unit 3200 receives information regarding a schedule of the user. The schedule information may include a plurality of pieces of event information. The event information may include, for example, information regarding a meeting, information regarding an event, and information regarding a birthday of an acquaintance of the user. The schedule information acquisition unit 3200 may acquire at least one of the schedule information of the user and schedule information of another user associated with the user from the user terminal 2000.

The schedule information acquisition unit 3200 may also acquire schedule information from the SNS server 4000. In this situation, the schedule information acquisition unit 3200 may receive the ID of the user terminal 2000 or the ID of the user from the user terminal 2000 and receive the schedule information of the user and schedule information of another user associated with the user from the SNS server 4000 based on the ID of the user terminal 2000 or the ID of the user.

The location information receiver 3300 receives information regarding a current location of the user terminal 2000 from the user terminal 2000. The information regarding a current location of the user terminal 2000 may include, for example, at least one of a GPS value, an ID of a base station, AP information, and an IP address.

The phone number recommendation list generator 3400 generates a phone number recommendation list based on a call history of the user terminal 2000. The phone number recommendation list generator 3400 may generate the phone number recommendation list by comparing each call breakdown included in the call history with a current time and a current location of the user terminal 2000.

The phone number recommendation list generator 3400 may calculate similarities to a current time and a current location of the user terminal 2000 with respect to each call breakdown included in the call history and determine phone numbers to be included in the phone number recommendation list based on the calculated similarities. In detail, the phone number recommendation list generator 3400 may calculate time similarity based on a similarity level between a current time and time information included in each call breakdown. The phone number recommendation list generator 3400 may calculate time similarity to time information included in each call breakdown based on, for example, at least one of a call start time, a talk time, a call date, a day of the week, and whether the call date is a holiday with respect to a terminal corresponding to a phone number included in a call breakdown. The time similarity may have a high value when a current time is similar to a call start time. The time similarity may also have a high value when a current date is similar to a call date. The time similarity may also have a high value when a current day of the week is similar to a call day of the week.

In addition, the phone number recommendation list generator 3400 may calculate location similarity based on a similar level between a current location of the user terminal 2000 and location information included in each call breakdown. The location similarity may have a high value when a current location of the user terminal 2000 is near to a location where a call has been performed. However, the present disclosure is not limited thereto, and the phone number recommendation list generator 3400 may calculate the time similarity and the location similarity according to various criteria and algorithms.

The phone number recommendation list generator 3400 may generate the phone number recommendation list based on schedule information of the user. The phone number recommendation list generator 3400 may check an event included in the schedule information by using the schedule information stored in the user terminal 2000 and insert a phone number included in the checked event into the phone number recommendation list. The phone number recommendation list generator 3400 may check events, such as, for example, a meeting, a conference, and a birthday of an acquaintance, in the schedule information of the user and extract phone numbers regarding the meeting, the conference, and the birthday of the acquaintance from the schedule information. In this situation, the phone number recommendation list generator 3400 may identify each event from the schedule information by using various natural language analysis schemes and extract a phone number from each event.

The phone number recommendation list generator 3400 may insert a phone number corresponding to an event into a phone number recommendation list generated on a date and a time corresponding to the event. For example, if Gil-Dong Hong's birthday is September 4^{th}, the phone number recommendation list generator 3400 may check Gil-Dong Hong's birthday in the schedule information. In addition, when the phone number recommendation list generator 3400 generates a phone number recommendation list on September 4^{th}, the phone number recommendation list generator 3400 may insert a phone number of Gil-Dong Hong into the phone number recommendation list.

The phone number recommendation list generator 3400 may generate a phone number recommendation list based on schedule information of an acquaintance. In this situation, the phone number recommendation list generator 3400 may generate the phone number recommendation list by using event information included in the schedule information of the acquaintance. The event information included in the schedule information of the acquaintance may include, for example, information regarding a birthday of the acquaintance or a meeting with the acquaintance.

The phone number recommendation list generator 3400 may also accumulate time similarity and location similarity information with respect to each call breakdown included in the call history, and generate a phone number recommendation list by using the accumulated similarities. In this situation, the phone number recommendation list generator 3400 may set a predetermined duration for accumulating similarities. The phone number recommendation list generator 3400 may also generate the phone number recommendation list by using a mean value of the time similarity and the location similarity.

The phone number recommendation unit 3500 provides the generated phone number recommendation list to the user terminal 2000.

The DB 3600 stores various kinds of information associated with the server 3000 to generate and provide the phone number recommendation list.

The transceiver 3700 transmits and receives various kinds of information to and from the user terminal 2000 and the SNS server 4000 in order for the server 3000 to generate and provide the phone number recommendation list.

The controller 3800 controls the entire operation of the server 3000, and controls the call history receiver 3100, the schedule information acquisition unit 3200, the location information receiver 3300, the phone number recommendation list generator 3400, the phone number recommendation unit 3500, the DB 3600, and the transceiver 3700 in order for the server 3000 to generate and provide the phone number recommendation list.

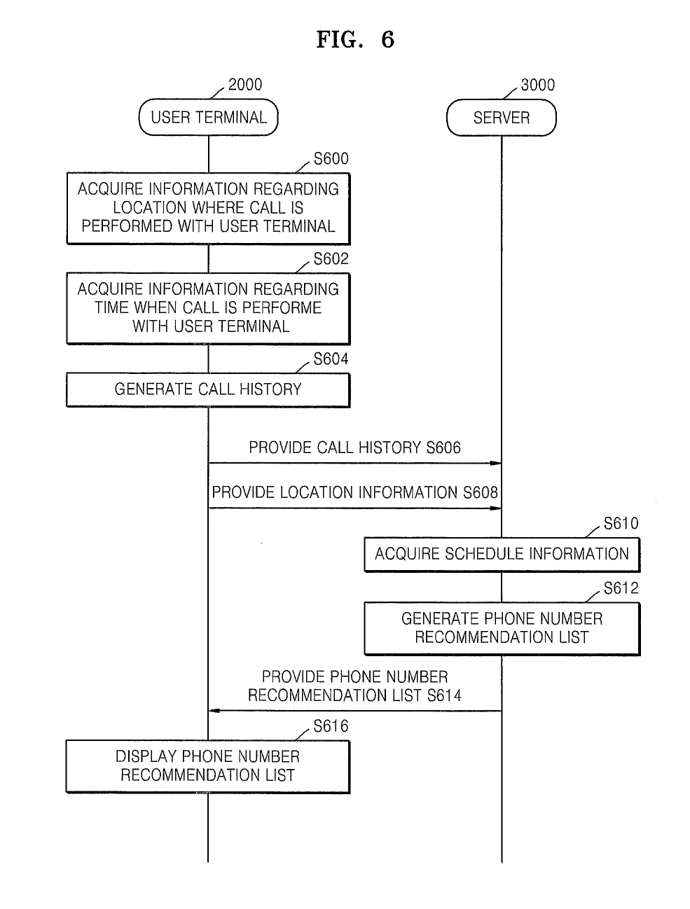

A method of recommending a phone number, according to another embodiment of the present disclosure, will now be described with reference to FIG. 6.

FIG. 6 is a signaling diagram illustrating a method of recommending a phone number, according to another embodiment of the present disclosure.

Referring to FIG. 6, in operation 5600, the user terminal 2000 acquires location information of a location where a call is performed with the user terminal 2000. The location information may include, for example, at least one of a GPS value, an ID of a base station, AP information, and an IP address.

In operation 5602, the user terminal 2000 receives time information of when the call is performed with the user terminal 2000. The user terminal 2000 may acquire information regarding a date, a time, and a day of the week when the call is performed. The user terminal 2000 may also acquire information regarding whether the date when the call is performed is a weekday or a holiday. The user terminal 2000 may also identify the time when the call is performed as a predetermined time period, and the predetermined time period may include at least one of, for example, dawn, morning, forenoon, noon, afternoon, evening, and night. The user terminal 2000 may also acquire time information of when the user accesses a phone menu of the user terminal 2000 to make a call.

In operation S604, the user terminal 2000 generates a call history by using the acquired location information and the acquired time information. The call history generated by the user terminal 2000 may include at least one of, for example, a phone number of a called terminal, a shortcut number, a location of the user terminal 2000, a call start time, a talk time, and a day of the week, but is not limited thereto. The call history may also include information regarding whether the call is an incoming call or an outgoing call. The call history may also include information regarding whether the date when the call is performed is a holiday.

In operation S606, the user terminal 2000 provides the generated call history to the server 3000.

In operation S608, the user terminal 2000 provides information regarding a current location of the user terminal 2000 to the server 3000. The information regarding a current location of the user terminal 2000 may include, for example, at least one of a GPS value, an ID of a base station, AP information, and an IP address.

In operation S610, the server 3000 acquires schedule information. In operation S610, the server 3000 may acquire at least one of schedule information of the user and schedule information of another user associated with the user. The schedule information may include a plurality of pieces of event information. The event information may include, for example, information regarding a meeting, information regarding an event, and information regarding a birthday of an acquaintance of the user. The server 3000 may acquire the schedule information from the user terminal 2000 but is not limited thereto. The server 3000 may also acquire schedule information from the SNS server 4000. In this situation, the server 3000 may receive the ID of the user terminal 2000 or the ID of the user from the user terminal 2000 and receive the schedule information of the user and schedule information of another user associated with the user from the SNS server 4000 based on the ID of the user terminal 2000 or the ID of the user.

In operation S612, the server 3000 generates a phone number recommendation list. The server 3000 may generate the phone number recommendation list based on the call history of the user terminal 2000. The server 3000 may generate the phone number recommendation list, by comparing each call breakdown included in the call history with a current time and a current location of the user terminal 2000.

The server 3000 may calculate similarities to a current time and a current location of the user terminal 2000 with respect to each call breakdown included in the call history and determine phone numbers to be included in the phone number recommendation list based on the calculated similarities. In detail, the server 3000 may calculate time similarity based on a similar level between a current time and time information included in each call breakdown. The server 3000 may calculate time similarity to time information included in each call breakdown based on, for example, at least one of a call start time, a talk time, a call date, a day of the week, and whether the call date is a holiday with respect to a terminal corresponding to a phone number included in a call breakdown. The time similarity may have a high value when a current time is similar to a call start time. The time similarity may also have a high value when a current date is similar to a call date. The time similarity may also have a high value when a current day of the week is similar to a call day of the week.

In addition, the server 3000 may calculate location similarity based on a similar level between a current location of the user terminal 2000 and location information included in each call breakdown. The location similarity may have a high value when a current location of the user terminal 2000 is near a location where a call has been performed. However, the present disclosure is not limited thereto, and the phone number recommendation list generator 3400 may calculate the time similarity and the location similarity according to various criteria and algorithms.

The server 3000 may generate the phone number recommendation list based on schedule information of the user. The server 3000 may check an event included in the schedule information by using the schedule information stored in the user terminal 2000 and insert a phone number included in the checked event into the phone number recommendation list. The server 3000 may check events, such as, for example, a meeting, a conference, and a birthday of an acquaintance, in the schedule information of the user and extract phone numbers regarding the meeting, the conference, and the birthday of the acquaintance from the schedule information. In this situation, the server 3000 may identify each event from the schedule information by using various natural language analysis schemes and extract a phone number from each event.

The server 3000 may insert a phone number corresponding to an event into a phone number recommendation list generated on a date and a time corresponding to the event. For example, if Gil-Doug Hong's birthday is September 4^{th}, the server 3000 may check Gil-Dong Hong's birthday in the schedule information. In addition, when the server 3000 generates a phone number recommendation list on September 4^{th}, the server 3000 may insert a phone number of Gil-Dong Hong into the phone number recommendation list.

The server 3000 may generate a phone number recommendation list based on schedule information of an acquaintance. In this situation, the server 3000 may generate the phone number recommendation list by using event information included in the schedule information of the acquaintance. The event information included in the schedule information of the acquaintance may include, for example, information regarding a birthday of the acquaintance or a meeting with the acquaintance.

The server 3000 may also accumulate time similarity and location similarity with respect to each call breakdown included in the call history, and generate a phone number recommendation list by using the accumulated similarities. In this situation, the server 3000 may set a predetermined duration for accumulating similarities. The server 3000 may also generate the phone number recommendation list by using a mean value of the time similarity and the location similarity.

In operation S614, the server 3000 provides the generated phone number recommendation list to the user terminal 2000.

In operation S616, the user terminal 2000 displays the phone number recommendation list on the screen of the user terminal 2000. The user terminal 2000 may insert the phone number recommendation list on the top of a call history list of the user terminal 2000. The user terminal 2000 may display the phone number recommendation list on the screen of the user terminal 2000 separately from the call history list of the user terminal 2000.

A call history according to an embodiment of the present disclosure will now be described with reference to FIG. 7.

FIG. 7 illustrates a call history table according to an embodiment of the present disclosure.

As shown in FIG. 7, the call history table includes an ID field 70, a phone number field 72, a type field 74, a call start time field 76, a talk time field 78, a location field 80, a day-of-the-week field 82, and a holiday field 84.

In the ID field 70, a shortcut number of a phone number stored in a user terminal may be recorded, and in the phone number field 72, a phone number of a terminal, which has made or received a call to or from the user terminal, may be recorded. In the type field 74, whether the call through the user terminal is an incoming call or an outgoing call may be recorded.

In the call start time field 76, a start time of the call through the user terminal may be recorded. In the call start time field 76, for example, information regarding a year, a month, a date, an hour, a minute, and a second when the call has been performed through the user terminal may be recorded. In the talk time field 78, information regarding a talk time may be recorded. In the location field 80, location information of a location where the call has been performed through the user terminal may be recorded.

In the location field 80, for example, a GPS coordinate value may be recorded, but the present disclosure is not limited thereto. In addition, data recorded in the location field may be used to calculate location similarity to a current location of the user terminal, but the present disclosure is not limited thereto.

In the day-of-the-week field 82, a day of the week corresponding to a date when the call has been performed through the user terminal may be recorded. In the holiday field 84, information regarding whether the date when the call has been performed through the user terminal is a holiday may be recorded.

Data recorded in the call start time field 76, the talk time field 78, the day-of-the-week field 82, and the holiday field 84 may be used to calculate time similarity to a current time, but the present disclosure is not limited thereto.

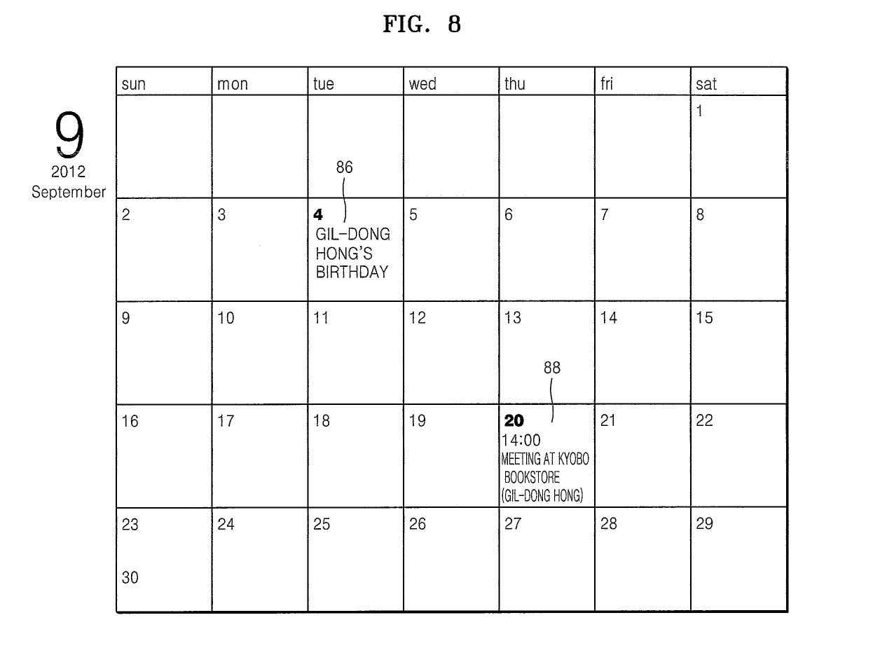

Schedule information according to an embodiment of the present disclosure will now be described with reference to FIG. 8.

FIG. 8 illustrates a schedule information table according to an embodiment of the present disclosure.

As shown in FIG. 8, in the schedule information table, data of a schedule of a user per date may be recorded. For example, in the schedule information table, event information 86 indicating that September 4^{th} is Gil-Dong Hong's birthday may be recorded. As another example, in the schedule information table, event information 88 indicating that a meeting with Gil-Dong Hong is reserved at Kyobo bookstore at 14:00 on September 20^{th} may be recorded. Event information recorded in the schedule information table may be analyzed by various natural language analysis schemes, and a phone number included in the event information may be extracted based on the analysis. If a name of another user is recorded in the schedule information table, a phone number corresponding to the recorded name may be extracted from a separate DB. In addition, the extracted phone number may be included in a phone number recommendation list according to a pre-set criterion.

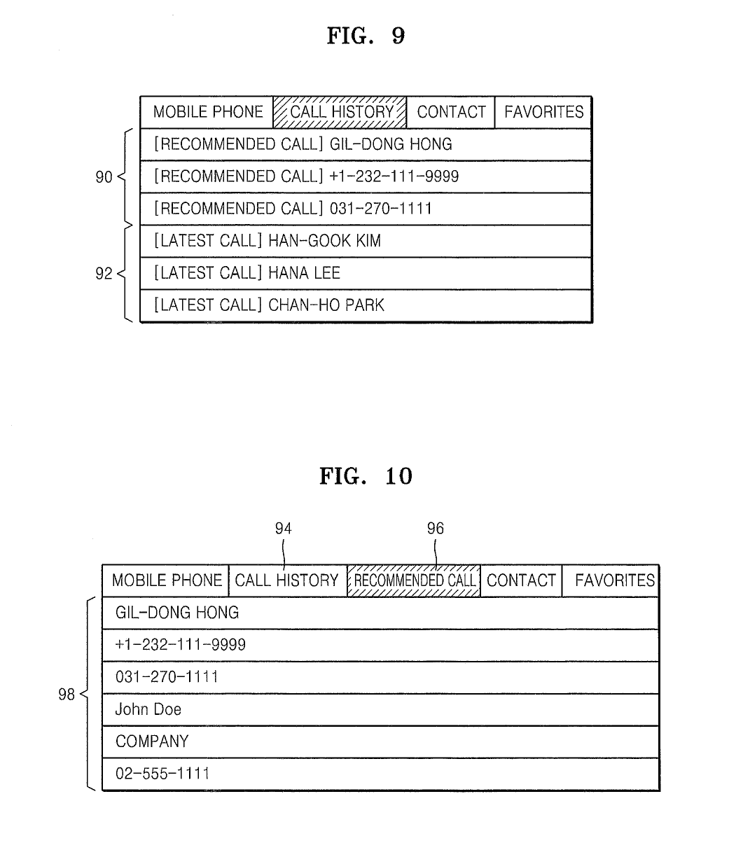

Examples of displaying a phone number recommendation list according to an embodiment of the present disclosure will now be described with reference to FIGS. 9 and 10.

FIGS. 9 and 10 illustrate displayed phone number recommendation lists 90 and 98 according to an embodiment of the present disclosure.

As shown in FIG. 9, the phone number recommendation list 90 may be displayed together with a call history list 92. In this situation, the phone number recommendation list 90 may be inserted into the top of the call history list 92.

As shown in FIG. 10, the phone number recommendation list 98 may be displayed separately from a call history list. In detail, a call history field 94 and a call recommendation field 96 may be separately displayed on a screen of a user terminal. In addition, if the call history field 94 is selected by a user input, the call history list may be displayed, and if the call recommendation field 96 is selected by a user input, the phone number recommendation list 98 may be displayed.

According to the embodiments of the present disclosure, a phone number may be recommended based on a call history of a user terminal.

In addition, a phone number may be effectively recommended to a user terminal based on a call history including location information and time information.

In addition, schedule information of a user and another user may be effectively collected, and a phone number may be recommended to a user terminal by using the collected schedule information.

The embodiments of the present disclosure may also be embodied in a form of a recording medium including computer-executable commands, such as a program module executed by a computer. A computer-readable medium may be a certain available medium that can be accessed by a computer and includes any volatile and non-volatile media and fixed-type and non-fixed-type media. In addition, the computer-readable medium may include any computer-storable media and communication media. A computer-storable medium includes any volatile and non-volatile media and fixed-type and non-fixed-type media embodied by any methods and techniques for storing information, such as a computer-readable command, a data structure, a program module, or other data. A communication medium typically includes a computer-readable command, a data structure, a program module, other data of a modulated data signal such as a carrier wave, or other transfer mechanism, and includes a certain information transfer medium.

The above-description of the present disclosure is only illustrative, and it will be understood by those of ordinary skill in the art that various changes in form and details may be made therein without departing from the technical spirit and essential features of the disclosure. Therefore, the exemplary embodiments should be considered in descriptive sense only and not for purposes of limitation. For example, each component described in a single type may be embodied in a distributed fashion, and likewise, components described in a distributed type may be embodied in a combined fashion.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A user terminal for generating a phone number recommendation list, the user terminal comprising:
a time information acquisition unit configured to acquire information regarding a time taken to perform a call through the user terminal;
a location information acquisition unit configured to acquire information regarding a location where the call is performed;
a call history generator configured to generate a call history of the user terminal based on the acquired time information and the acquired location information;
a phone number recommendation unit configured to generate a phone number recommendation list based on the generated call history, a current location of the user terminal, and a current time; and
a display unit configured to display the generated phone number recommendation list.

2. The user terminal of claim 1, further comprising a schedule information acquisition unit configured to acquire schedule information of a user associated with the user terminal,
wherein the phone number recommendation unit generates the phone number recommendation list based on the acquired schedule information.

3. The user terminal of claim 2, wherein the schedule information acquisition unit acquires schedule information of another user associated with another user terminal from a Social Network Service (SNS) server by using an identification (ID) of the user terminal or an ID of the user, and
the phone number recommendation unit generates the phone number recommendation list by using the schedule information of the user and the schedule information of another user.

4. The user terminal of claim 2, wherein the phone number recommendation unit generates the phone number recommendation list based on a similarity to the current location of the user terminal, a similarity to the current time, and event information included in the schedule information.

5. The user terminal of claim 4, wherein the event information includes at least one of information regarding a birthday of an acquaintance of the user and information regarding a meeting with the acquaintance, and
the phone number recommendation unit inserts a phone number of the acquaintance into the phone number recommendation list based on an identifying value of the acquaintance, which is included in the event information.

6. The user terminal of claim 1, wherein the time information includes at least one of information regarding a date when the call is performed, information regarding a day of the week when the call is performed, and information regarding a time when the call is performed, and
the information regarding the date when the call is performed includes information regarding whether the date is a holiday.

7. The user terminal of claim 1, wherein the display unit inserts the phone number recommendation list into a top of a call history list of the user terminal.

8. The user terminal of claim 1, wherein the display unit displays the phone number recommendation list separately from a call history list of the user terminal.

9. A user terminal for receiving a phone number recommendation list, the user terminal comprising:
a time information acquisition unit configured to acquire information regarding a time taken to perform a call through the user terminal;
a location information acquisition unit configured to acquire information regarding a location where the call is performed;
a call history provider configured to provide to a server a call history of the user terminal that is generated based on the acquired time information and the acquired location information;
a location information provider configured to provide the location information of the user terminal to the server;
a recommended phone number receiver configured to receive from the server a phone number recommendation list that is generated by the server based on the provided call history, the provided location information, and a current time; and
a display unit configured to display the received phone number recommendation list.

10. The user terminal of claim 9, further comprising a schedule information provider configured to provide schedule information of a user associated with the user terminal to the server,
wherein the recommended phone number receiver receives the phone number recommendation list generated by the server based on the provided schedule information.

11. The user terminal of claim 10, wherein the recommended phone number receiver receives the phone number recommendation list generated by the server based on the schedule information of another user associated with another user terminal, and
the schedule information of the other user is acquired from a Social Network Service (SNS) server by using an identification (ID) of the user terminal or an ID of the user.

12. The user terminal of claim 10, wherein the recommended phone number receiver receives the phone number recommendation list generated based on a similarity to the current location of the user terminal, a similarity to the current time, and event information included in the schedule information.

13. The user terminal of claim 12, wherein the event information includes at least one of information regarding a birthday of an acquaintance of the user and information regarding a meeting with the acquaintance, and
a phone number of the acquaintance is included in the phone number recommendation list based on an identifying value of the acquaintance, which is included in the event information.

14. The user terminal of claim 9, wherein the time information includes at least one of information regarding a date when the call is performed, information regarding a day of the week when the call is performed, and information regarding a time when the call is performed, and
the information regarding the date when the call is performed includes information regarding whether the date is a holiday.

15. The user terminal of claim 9, wherein the display unit inserts the phone number recommendation list into a top of a call history list of the user terminal.

16. The user terminal of claim 9, wherein the display unit displays the phone number recommendation list separately from a call history list of the user terminal.

17. A server for providing a phone number recommendation list, the server comprising:
a call history receiver configured to receive a call history of a user terminal, which includes information regarding a time taken to perform a call through the user terminal and information regarding a location where the call is performed;
a location information receiver configured to receive location information of the user terminal;
a phone number recommendation list generator configured to generate a phone number recommendation list based on the received call history, the received location information, and a current time; and
a phone number recommendation unit configured to provide the generated phone number recommendation list to the user terminal.

18. The server of claim 17, further comprising a schedule information acquisition unit configured to acquire schedule information of a user associated with the user terminal,
wherein the phone number recommendation list generator generates the phone number recommendation list based on the acquired schedule information.

19. The server of claim 18, wherein the schedule information acquisition unit acquires schedule information of another user associated with another user terminal from a Social Network Service (SNS) server by using an identification (ID) of the user terminal or an ID of the user, and
the phone number recommendation list generator generates the phone number recommendation list by using the schedule information of the user and the schedule information of the other user.

20. The server of claim 18, wherein the phone number recommendation list generator generates the phone number recommendation list based on a similarity to a current location of the user terminal, a similarity to the current time, and event information included in the schedule information.

21. The server of claim 20, wherein the event information includes at least one of information regarding a birthday of an acquaintance of the user and information regarding a meeting with the acquaintance, and
the phone number recommendation list generator inserts a phone number of the acquaintance into the phone number recommendation list based on an identifying value of the acquaintance, which is included in the event information.

22. The server of claim 17, wherein the time information includes at least one of information regarding a date when the call is performed, information regarding a day of the week when the call is performed, and information regarding a time when the call is performed, and
the information regarding the date when the call is performed includes information regarding whether the date is a holiday.

23. The server of claim 17, wherein the phone number recommendation list in the user terminal is inserted into a top of a call history list of the user terminal.

24. The server of claim 17, wherein the phone number recommendation list in the user terminal is displayed separately from the call history list of the user terminal.

25. A method of generating a phone number recommendation list in a user terminal, the method comprising:
acquiring information regarding a time taken to perform a call through the user terminal;
acquiring information regarding a location where the call is performed;
generating a call history of the user terminal based on the acquired time information and the acquired location information;
generating a phone number recommendation list based on the generated call history, a current location of the user terminal, and a current time; and
displaying the generated phone number recommendation list.

26. A method of receiving a phone number recommendation list in a user terminal, the method comprising:
acquiring information regarding a time taken to perform a call through the user terminal;
acquiring information regarding a location where the call is performed;
providing to a server a call history of the user terminal that is generated based on the acquired time information and the acquired location information;
providing the location information of the user terminal to the server;
receiving from the server a phone number recommendation list that is generated by the server based on the provided call history, the provided location information, and a current time; and
displaying the received phone number recommendation list.

27. A method of providing a phone number recommendation list in a server, the method comprising:
receiving a call history of a user terminal, which includes information regarding a time taken to perform a call through the user terminal and information regarding a location where the call is performed;
receiving location information of the user terminal;
generating a phone number recommendation list based on the received call history, the received location information, and a current time; and
providing the generated phone number recommendation list to the user terminal.

28. A computer program product comprising a non-transitory computer-readable recording medium encoded with computer-executable instructions that when executed cause a data processing system to perform:
acquiring information regarding a time taken to perform a call through the user terminal;
acquiring information regarding a location where the call is performed;
generating a call history of the user terminal based on the acquired time information and the acquired location information;
generating a phone number recommendation list based on the generated call history, a current location of the user terminal, and a current time; and
displaying the generated phone number recommendation list.

29. A computer program product comprising a non-transitory computer-readable recording medium encoded with computer-executable instructions that when executed cause a data processing system to perform:
acquiring information regarding a time taken to perform a call through the user terminal;
acquiring information regarding a location where the call is performed;
providing to a server a call history of the user terminal that is generated based on the acquired time information and the acquired location information;
providing the location information of the user terminal to the server;
receiving from the server a phone number recommendation list that is generated by the server based on the provided call history, the provided location information, and a current time; and
displaying the received phone number recommendation list.
